(19) United States
(12) Patent Application Publication
(10) Pub. No.: US 2013/0070752 A1
(43) Pub. Date: Mar. 21, 2013

(54) SYSTEM AND METHOD FOR COMPUTING INTER-DOMAIN SHORTEST CONSTRAINED PATH IN A COMPUTER NETWORK

(71) Applicant: Huawei Technologies Co., Ltd., Shenzhen (CN)

(72) Inventors: Dhody Dhruv, Bangalore (IN); Shastry Pradeepa, Bangalore (IN)

(73) Assignee: Huawei Technologies Co., Ltd., Shenzhen (CN)

(21) Appl. No.: 13/623,713

(22) Filed: Sep. 20, 2012

(30) Foreign Application Priority Data
Sep. 20, 2011 (IN) IN3238/CHE/2011

(51) Int. Cl. H04L 12/28

(52) U.S. Cl. 370/351

(57) ABSTRACT

System and method for computing inter-domain shortest constrained path or optimal path across unknown sequence of domains is described. The method comprises of sending a request by a path computation client (PCC) to a path computation element (PCE) serving an ingress domain; forwarding the request by the path computation element to each adjacent path computation elements (PCEs), each adjacent path computation element serving one or more domains, wherein said domains are non-traversed; forwarding the request by each adjacent path computation elements to next adjacent path computation element until a response is received from the path computation element of the domain having a destination node; computing the virtual shortest path tree path by each adjacent path computation element based on the response received; and selecting the optimal path from the virtual shortest path tree between the PCC and the destination node by the path computation element serving the ingress domain.

### CROSS-REFERENCE TO RELATED APPLICATIONS

This application claims priority to Indian Patent Application No. IN3238/CHE/2011, filed on Sep. 20, 2011, which is hereby incorporated by reference in its entirety.

### TECHNICAL FIELD

The present invention relates to telecommunications and more particularly to a system and method for computing inter-domain shortest constrained path or optimal path across unknown sequence of domains in a computer network.

### BACKGROUND

A communication network is a set of geographically distributed nodes and communication links between the nodes for data transmission. When the communication network becomes huge, management and maintenance will be difficult. Therefore, to facilitate management, the communication network is usually divided into multiple routing domains or autonomous systems (ASs). A domain is any collection of network elements within a common sphere of address management or path computation responsibility. Examples of domains include areas, AS, and multiple ASs. When nodes are added for data exchange, inter-domain routers that execute inter-domain routing protocols are adopted to interconnect the nodes in different domains. Such inter-domain routers are also referred to as border routers.

The emergence and development of Multi-Protocol Label Switching (MPLS) technology meets the new requirements for data network development, such as guaranteed available bandwidth and fast restoration. The MPLS technology allows the establishing of end-to-end tunnels in an IP/MPLS network having Label Switched Routers (LSRs). Such tunnels are generally referred to as Label Switch Paths (LSPs). LSP establishment involves the computation of a path of an LSR in the network, which is generally called route computation.

In some networks, such as Multi-Protocol Label Switching (MPLS) networks and Generalized MPLS (GMPLS) networks, a Traffic Engineering (TE) Label Switched Path (LSP) can be established by MPLS (or GMPLS) with a path provided by a Path Computation Client (PCC) and a Path Computation Element (PCE). Specifically, the PCC requests a path or route from the PCE, and the PCE computes the path and forwards the computed path information back to the PCC.

Path computation for tunnels of a computer network, e.g., label switched paths (LSPs), may be performed by head-end nodes of the tunnels, or by specialized Path Computation Elements (PCEs). While head-end nodes of tunnels may often be equipped to compute a suitable path for a tunnel, PCEs offer a variety of benefits not generally available to head-end nodes. For instance, PCEs may have advanced knowledge of the network topology, such as knowledge of existing tunnels through the network of which the head-end nodes may not be aware, visibility in other domains, etc. In addition, PCEs may be configured to communicate with other PCEs, such as for inter-domain (inter-area and/or inter-Autonomous-System, “inter-domain”) path computation.

The path can comprise a plurality of nodes and/or Label Switch Routers (LSRs) and extend from a source node or LSR to a destination node or LSR. In some cases, the path may be a point-to-point (P2P) path, which is computed across single or multiple areas or Autonomous System (AS) domains. In other cases, the path may be a Point-to-Multipoint (P2MP) path from a source node to a plurality of destination nodes, which may be referred to as a tree.

The path computation is done by a mechanism Backward-Recursive PCE-Based Computation (BRPC) procedure which describes a mechanism to compute inter-domain constrained paths by cooperating PCE (Path Computation Elements). The procedure works well when the sequence of domains to be traversed is either administratively predetermined or discovered by some means.

The above-mentioned procedure is unable to compute optimal path when the domain to which the destination node belongs is unknown or the sequence of domains to be traversed to reach the destination is also unknown. The administrator requires configuring or pre-determining by some external means the sequence of domains to be traversed to allow the above procedure to be applied.

There are many techniques and methods to establish the optimum path when the sequence of domains is not known in advance.

The first technique is the deployment of hierarchical PCE architecture in which a parent PCE maintains a domain topology map that contains the child domains and their interconnections. Parent PCE has no information about the resource availability within the child domain or the availability of connectivity across each domain.

The second technique is forward search procedure for computing P2P TE LSP crossing a number of domains through multiple PCEs. This is further described in Draft-chen-pce-forward-search-p2p-path-computation document.

However, the above-mentioned techniques are inefficient as both of them require lot of architectural changes, additional PCEs, modifications in Path computation element protocol (PCEP), Constrained shortest path first (CSPF). These above techniques are time-consuming for computing an end-to-end, multi domain path when the sequence of domains is not known in advance. Hence, there is a need of a system and method to overcome the afore-said problems as provided by the instant invention.

### SUMMARY

The primary aspect of the present invention is to provide a system and method for computing inter-domain shortest constrained path when the destination domain or domain sequence is not known in advance.

Another aspect of the present invention is to provide a system and method that can compute inter-domain shortest constrained path by allowing minor modifications to Path computation element communication protocol and computing/network elements.

Further aspect of the present invention is to provide a system and method that can be applied to environments with multiple number of domains.

According to an embodiment of the present invention, it provides a method for computing inter-domain optimal path in a network, the method comprising the steps of sending a request by a path computation client (PCC) to a path computation element (PCE) serving an ingress domain; forwarding the request by the path computation element to each adjacent path computation elements (PCEs), each adjacent path computation element serving one or more domains, wherein said domains are non-traversed; forwarding the request by each adjacent path computation elements to next adjacent path computation element until a response is received from the path computation element of the domain having a destination node; computing the virtual shortest path tree path by each adjacent path computation element based on the response received; and selecting the optimal path from the virtual shortest path tree between the PCC and the destination node by the path computation element serving the ingress domain.

According to another embodiment of the present invention, it provides a system comprising of a path computation client (PCC) adapted to send a request to a path computation element (PCE) serving an ingress domain; path computation element adapted to forward the request to each adjacent path computation elements (PCEs) serving one or more domains; wherein said domains are non-traversed; each adjacent path computation elements adapted to forward the request to next adjacent path computation element until a response is received from the path computation element of the domain having a destination node; path computation element adapted to compute the virtual shortest path tree path based on the response received; and path computation element adapted to select the optimal path from the virtual shortest path tree between the PCC and the destination node.

According to yet another embodiment of the present invention, it also provides a network component for computing inter-domain optimal path in a network, the network component comprising one or more network interfaces; at least one processor connected to a network interface, said processor adapted to receive a request from a path computation client (PCC); forward the request to each adjacent path computation elements (PCEs) serving one or more domains; wherein said domains are non-traversed; forward the request to next adjacent path computation elements by each adjacent path computation elements until a response is received from the path computation elements of the domain having a destination node; computing the virtual shortest path tree path by each adjacent path computation elements based on the response received; and selecting the optimal path from the virtual shortest path tree between the PCC and the destination node.

### BRIEF DESCRIPTION OF THE DRAWINGS

The advantages and features of the present invention will become better understood with reference to the following detailed description taken in conjunction with the accompanying drawings. The detailed description is described with reference to the accompanying figures. In the figures, the left-most digit(s) of a reference number identifies the figure in which the reference number first appears. The same numbers are used throughout the drawings to reference like features and components.

FIG. 1 is a schematic diagram of a network structure illustrating inter-domain path computation in the prior art;

FIGS. 2a to 2g are schematic diagrams of a network structures illustrating inter-domain path computation according to an embodiment of the present invention;

FIGS. 3 and 4 are flow charts illustrating path computation method according to an embodiment of the present invention;

FIG. 5 is a schematic diagram of a network component configured to implement inter-domain path computation method according to an embodiment of the present invention;

### DETAILED DESCRIPTION OF EMBODIMENTS

System and method for computing inter-domain shortest constrained path across unknown sequence of domains in a computer network is described. The system and method is not intended to be restricted to any particular form or arrangement, or any specific embodiment, or any specific use, disclosed herein, since the same may be modified in various particulars or relations without departing from the spirit or scope of the claimed invention herein shown and described. The system and/or method shown is intended only for illustration and disclosure of an operative embodiment and not to show all of the various forms or modifications in which this invention might be embodied or operated.

The present invention provides a system and method for calculating an inter-domain shortest constrained path across a plurality of domains, particularly when the destination domain is unknown or the domain sequence is not pre-determined. The technique or mechanism deployed in the present invention can be stated as BRPC-Flooding and can be applied with little modifications on protocols such as path computation element communication protocol and network elements. The path can be computed using a Path computation client (PCC) and plurality of Path computation elements (PCEs), each PCE associated with one or more domains. The PCE is an entity that is capable of computing a network path or route based on a network graph and applying computational constraints. A PCC is a client application requesting a path computation to be performed by the Path computation element.

The mechanism allows the request for computing optimal path from PCC to the PCE in its domain to be broadcasted or transmitted to each adjacent path computation element, wherein each adjacent path computation element serves one or more domains that are adjacent to each other. The sequence of adjacent domains is non-traversed i.e. it is not pre-determined by any means and is unknown. The domain which has the destination node creates a tree of potential paths to the destination (Virtual Shortest Path Tree-VSPT) and passes this back to the previous PCE in a Path computation reply message (PCRep). Each PCE in turn adds to the VSPT and passes it back until the PCE that has sent the request uses the VSPT and select best optimal path and forwards it to PCC.

The techniques described herein may be used in many different operating environments and systems. An exemplary environment that is suitable for practicing various implementations is discussed in the following section with respect to the accompanying figures.

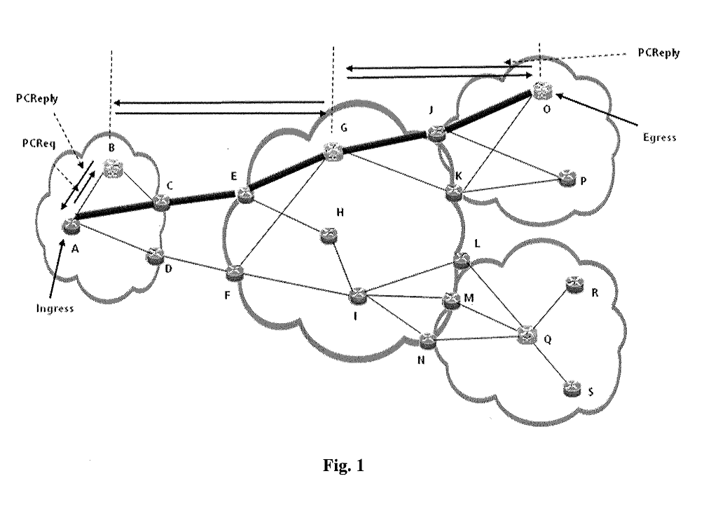

FIG. 1 is a schematic diagram of a network structure 100 illustrating inter-domain path computation in the prior art. The network structure can be label switched network which may be packet switched network in which data traffic may be transported using packets or frames along network paths or routes. The label switched network comprises a plurality of domains interconnected via logical means such as network topology, protocols, communication layers etc. and physical means such as connections etc. The domains may comprise plurality of nodes as shown in the diagram. The nodes can be plurality of source or ingress node, plurality of boundary nodes, plurality of branch nodes, plurality of transit nodes, destination node. As shown in the diagram, A is the source node, B, is the transit node, E and J are boundary nodes, G is the branch node and O is the destination node. The computation of the inter-domain path between the ingress or source node and the destination node may be distributed between pre-determined PCEs as the domain path i.e. the set of domains traversed to reach the destination domain is either administratively predetermined or discovered by some means. The Path computation request message (PCReq) is sent by an ingress node or PCC to the Path computation element in its domain. The request is forwarded along a pre-determined path through path computation elements of all the domains to reach the domain having the destination node. The pre-determined path through which request is forwarded is shown in the figure as ABCEGJO. The Path computation reply message (PCRep) is received from the destination node and follows through the same sequence as PCReq message. The shortest path between the source and the destination node is computed using Backward Recursive PCE-Based Computation (BRPC) procedure as follows.

Definition of VSPT(i)

In each domain i:
There is a set of X-en(i) entry BNs noted BN-en(k,i) where BN-en(k,i) is the kth entry BN of domain(i).
There is a set of X-ex(i) exit BNs noted BN-ex(k,i) where BN-ex(k,i) is the kth exit BN of domain(i).

VSPT(i): MP2P (multipoint-to-point) tree returned by PCE(i) to PCE(i−1):

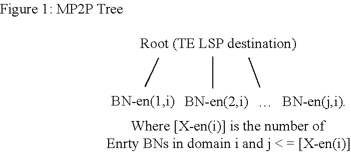

Each link of tree VSPT(i) represents the shortest constrained path between BN-en(j,i) and the TE LSP destination that satisfies the set of required constraints for the TE LSP (bandwidth, affinities, etc.). These are path segments to reach the TE LSP destination from BN-en(j,i).

PCE(n) computes VSPT(n), the tree made of the list of shortest constrained paths between every BN-en(j,n) and the TE LSP destination using a suitable path computation algorithm (e.g., CSPF) and returns the computed VSPT(n) to PCE(n−1).

Step i:

For i=n−1 to 2: PCE(i) computes VSPT(i), the tree made of the shortest constrained paths between each BN-en(j,i) and the TE LSP destination. It does this by considering its own TED and the information in VSPT(i+1).

In the case of inter-AS TE LSP computation, this also requires adding the inter-AS TE links that connect the domain(i0 to the domain(i+1).

Step n:

Finally, PCE(1) computes the end-to-end shortest constrained path from the source to the destination and returns the corresponding path to the requesting PCC in the form of a PCRep message as defined in [RFC5440].

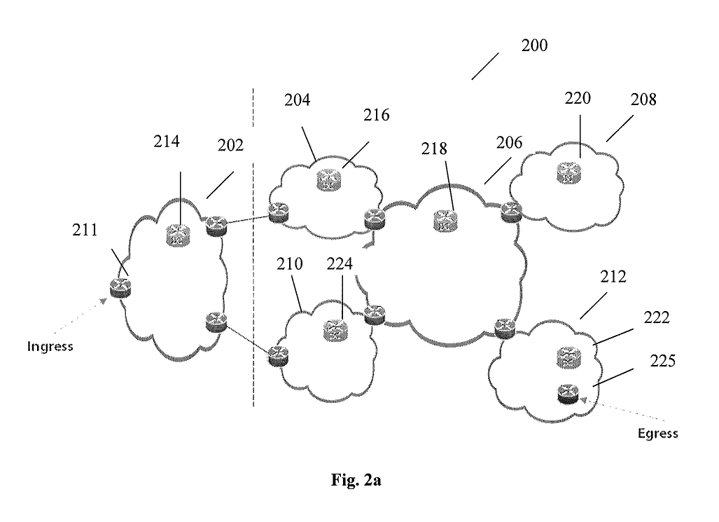

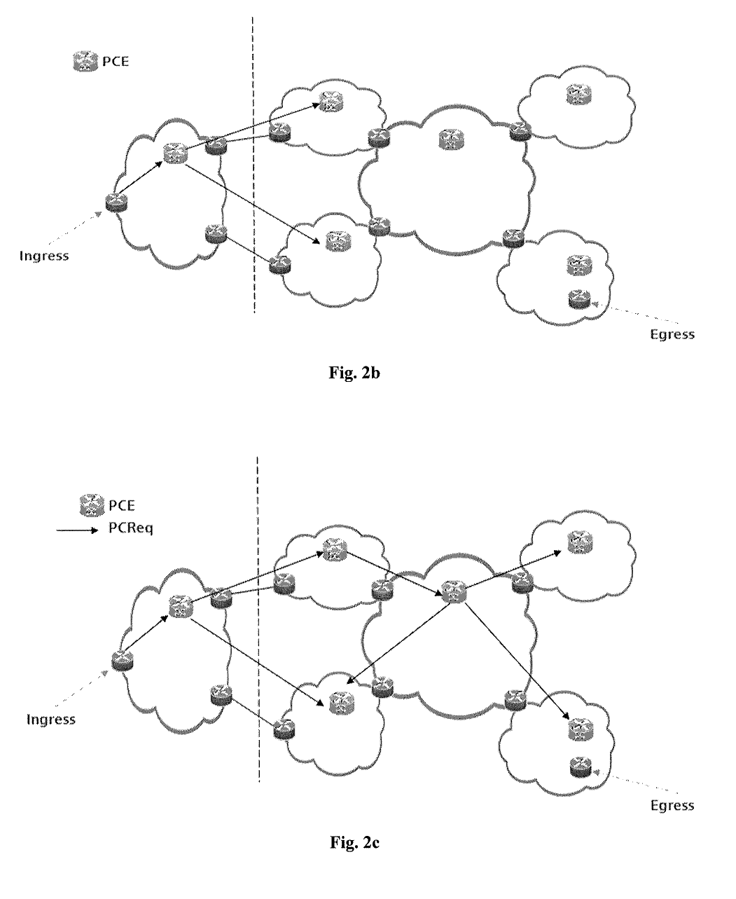

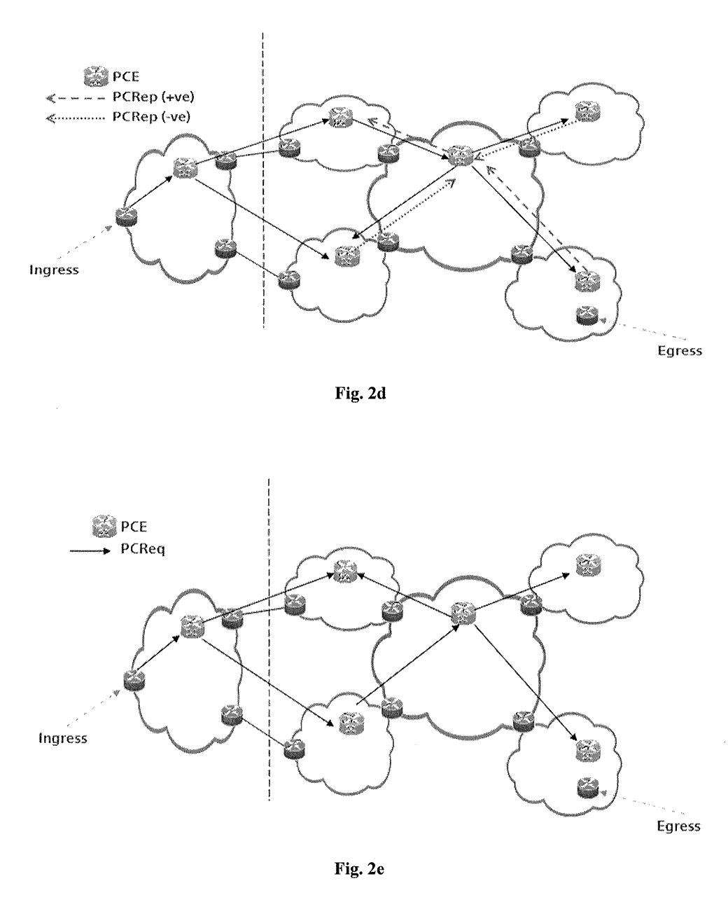

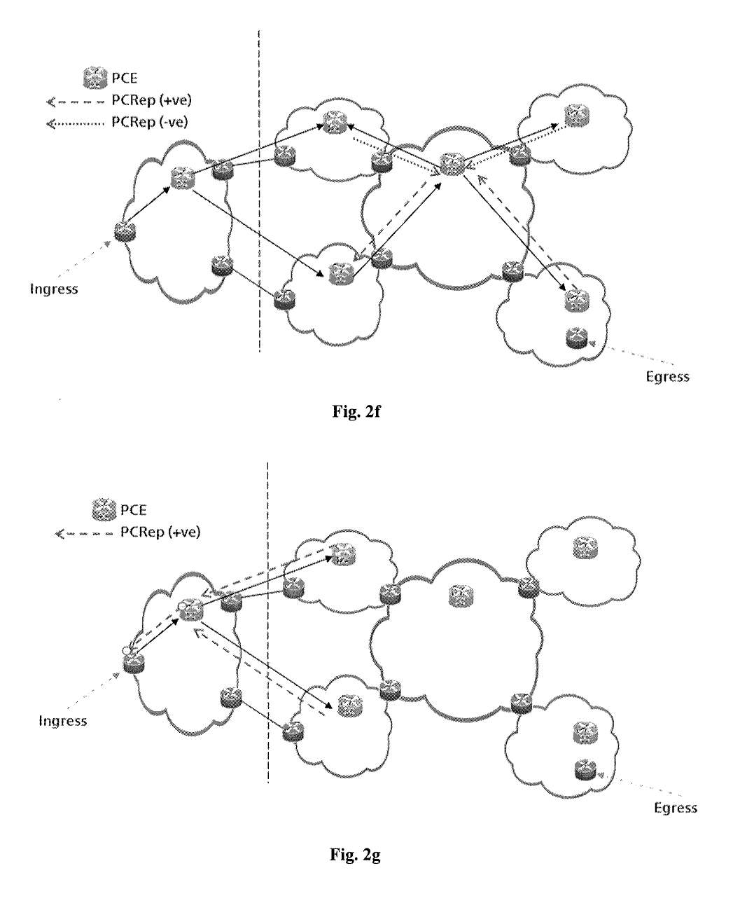

FIGS. 2a to 2g are schematic diagrams of a network structures illustrating inter-domain path computation according to an embodiment of the present invention;

As can be seen in FIG. 2a, the network structure 200 can be label switched network in which plurality of domains 202, 204, 206, 208, 210 and 212 are interconnected with each other through physical or logical means. The domains can include AS domains or interior gateway protocol (IGP) areas. The domains may comprise plurality of nodes which are connected via a plurality of paths and links. The nodes can include bridges, switches, routers or various combinations of such devices. The nodes may comprise a plurality of ingress ports for receiving packets from other nodes, logic circuitry to determine which nodes frames or packets are to be sent, a plurality of egress ports for transmitting frames to other nodes. The first 211 and last node 225 along a path may be referred as source node and destination node respectively. The nodes can be located in different domains and can be configured to communicate across multiple domains.

The domains can also include PCEs 214, 216, 218, 220, 222 and 224 that is configured to perform all or part of the path computation for the label switched network based on path computation request. The PCE can receive the information from the node that can be used for computing the optimal path from the source to the destination node. The PCE can be located in a component outside of the label switched network 200 such as external server or can be located in a component within a network such as node. A plurality of PCEs can be associated to a plurality of domains and can perform path computation to determine the best optimal path.

According to an embodiment of the invention, the domains as shown in FIG. 2 are non-traversed i.e. the sequence of domains to be traversed to locate shortest path between source node and destination node is not determined in advance. The accompanying figures shall illustrate on determining the destination node.

FIGS. 2b and 2c depicts that a request for path computation (PCReq) is sent by an ingress node 211 to the PCE 214 in its domain 202. Since, the path is not determined the PCE 214 forwards the request to adjacent PCEs 216 and 224 in domains 204 and 210 respectively. The PCEs 216 again forward the request to next adjacent PCE 218 which forwards it to PCEs 220, 222 and 224.

Each PCE to which request is forwarded can compute the path by cooperating with traffic engineering database and considering bandwidth and other constraints applicable to PCReq.

As can be seen in FIG. 2d, the domain 212 having a destination node sends a reply (PCRep) with a success and other PCEs in the other domains reply with No-Path message.

FIG. 2e depicts that a request for path computation (PCReq) is sent by an ingress node 211 to the PCE 214 in its domain 202. Since, the path is not determined the PCE 214 forwards the request to adjacent PCEs 216 and 224 in domains 204 and 210 respectively. The PCEs 224 again forward the request to next adjacent PCE 218 which forwards it to PCEs 220, 222 and 216.

As can be seen in FIG. 2f, the domain 212 having a destination node sends a reply (PCRep) with a success and other PCEs in the other domains reply with No-Path message.

The domain 212 which has the destination node creates a tree of potential paths to the destination (Virtual Shortest Path Tree-VSPT) and passes this back to the previous PCE in a Path computation reply message (PCRep). Each PCE in turn adds to the VSPT and passes it back until the PCE 214 that has sent the request PCReq uses the VSPT and select best optimal path and forwards it to ingress node or PCC as depicted in FIG. 2g. The shortest path is computed using BRPC procedure or Constrained shortest path first (CSPF) procedure as mentioned above.

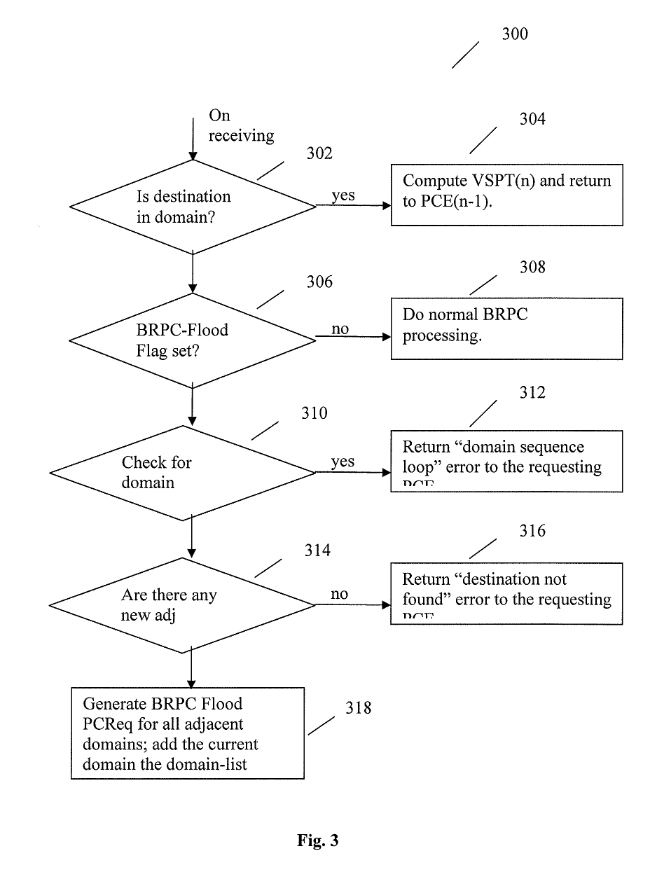

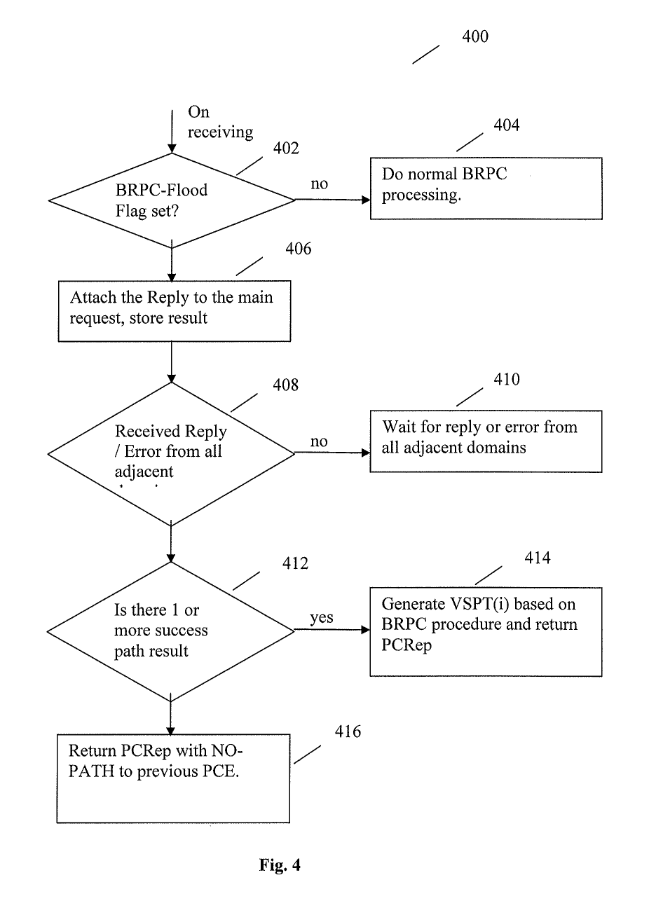

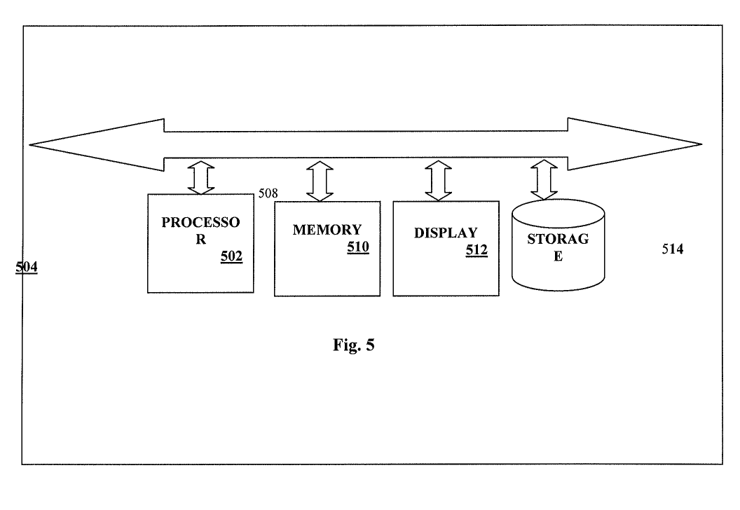

The functioning of the network structures can be further illustrated with the help of flowcharts by referring to FIGS. 3 and 4.

FIGS. 3 and 4 are flow charts illustrating path computation method according to an embodiment of the present invention. As already stated above, the method is enabled to compute path across plurality of domains when the domain sequence is not known in advance.

FIG. 3 is a flow diagram 300 indicating the first step of path computation, when a request for path computation (PCReq) is sent by the PCC to the PCE in its domain.

At 302, on receiving the request from the PCE 214 by the adjacent domains, it is checked if the destination node is in said adjacent domains. If the destination node is in the adjacent domain, then at 304 it creates a tree of potential paths to the destination (Virtual Shortest Path Tree-VSPT) and passes this back to the previous PCE in a Path computation reply message (PCRep).

At 306, the “BRPC-Flood” flag request is checked, if the flag is set then the domain sequence loop is checked at 310 to avoid the already visited adjacent domain to be traversed again. The domain sequence loop is the loop which is formed from the traversed domains. The “BRPC-Flood” flag is a new flag added in the RP object. If the flag is set the domain sequence as encoded in the Include Route Object (IRO) indicates that the domains traversed so far and not the pre-determined exact domain sequence to be traversed to reach the destination. The RP (Request Parameters) object can be part of a request message transmitted from the PCC or a reply message transmitted from a PCE. The RP object can also be exchanged between the PCEs associated with different domains. If the domain sequence loop exists, at 312 it returns an error to previous PCE or requesting PCE. If the “BRPC-Flood” flag is not set, then at 308 the destination domain is determined through well known sequence of domains that has already been determined earlier.

At 314, it is checked if there exist anymore adjacent domains so that request can be forwarded further to determine destination node. If there are no more adjacent domains, then at 316 an error “destination not found” is returned to the requesting PCE.

At 318, if there are more adjacent domains then “BRPC Flood” PCReq is generated for all said adjacent domains and the traversed domain is added to the domain list maintained by each PCE in adjacent domains.

FIG. 4 is a flow diagram 400 indicating the second step of path computation, when a reply for path computation is received (PCRep) from the destination node.

At 402, the “BRPC-Flood” flag is checked, if the flag is set the reply is attached to the request sent by each PCE and the result is stored for later path computation. If the flag is not set, then at 404 the destination domain is determined through well known sequence of domains that has already been determined earlier.

At 408, it is checked if the reply or error is received from all adjacent domains. The reply indicates the success path of the destination node and error can be domain sequence loop or destination node not found. If the reply/error is not received from all adjacent domains then at 410 the previous PCE waits for the same from all the adjacent domains so that if at least one of the reply is success path, the PCE(i) can calculate VSPT(i) according to BRPC procedure.

At 412, it is checked if there exists one or more success paths from the destination node. If it exists then at 414, the virtual shortest path is calculated using BRPC or CSPF procedure as indicated above and PCRep is sent to the requesting PCE 214 which then forwards the same to the PCC. If no success path exists, then PCRep with NO-PATH is sent to previous PCE.

FIG. 5 is a schematic diagram of a network component configured to implement inter-domain path computation method according to an embodiment of the present invention;

The network components such as node that can be deployed as PCC or PCE can be implemented on any general purpose computer system 500 can operate as a standalone device or may be connected, e.g., using a network, to other computer systems or peripheral devices. In a networked deployment, the computer system can operate in the capacity of a server or as a client user computer in a server-client user network environment, or as a peer computer system in a peer-to-peer (or distributed) network environment. The computer system 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device. It can also be implemented using electronic devices that provide voice, video or data communication.

The computer system 500 can include a processor 502, such as, a central processing unit (CPU), a graphics processing unit (GPU), or both. The processor 502 can be one or more general processors, digital signal processors, application specific integrated circuits, field programmable gate arrays, servers, networks, digital circuits, analog circuits, combinations thereof, or other now known or later developed devices for analyzing and processing data.

The computer system 500 can include a memory 510 that can communicate via a bus 508. The memory 510 can be a main memory, a static memory, or a dynamic memory. The memory 510 can include various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 510 may include a cache or random access memory for the processor 502. The memory 510 can be an external storage device 514 or database for storing data and can include a hard drive, compact disc (“CD”), digital video disc (“DVD”), memory card, memory stick, floppy disc, universal serial bus (“USB”) memory device, or any other device operative to store data. The memory 510 can be operable to store instructions executable by the processor 502. The processing strategies can include multiprocessing, multitasking, parallel processing and the like.

The computer system 500 can further include a display 512, such as a liquid crystal display (LCD), an organic light emitting diode (OLED), a flat panel display, a solid state display, a cathode ray tube (CRT), a projector, a printer or other now known or later developed display device for outputting determined information. Additionally, the computer system 500 can include an input/output device 506 configured to allow a user to interact with any of the components of system. The input device 506 may be a number pad, a keyboard, or a cursor control device, such as a mouse, or a joystick, touch screen display, remote control or any other device operative to interact with the system.

The computer system 500 can include a communication interface 516 for transmitting or receiving the instructions over the network 518. The communication interface 516 can be a part of the processor 502 or can be a separate component. The communication interface can be created in software or may be a physical connection in hardware. The communication interface 516 can be configured to connect with a network 518, external media, the display 512, or any other components in system 500, or combinations thereof. The connection with the network 518 can be a physical connection, such as a wired Ethernet connection or may be established wirelessly.

The embodiments described above and illustrated in the figures are presented by way of example only and are not intended as a limitation upon the concepts and principles of the present invention. Elements and components described herein may be further divided into additional components or joined together to form fewer components for performing the same functions. As such, it will be appreciated by one having ordinary skill in the art that various changes in the elements and their configuration and arrangement are possible without departing from the spirit and scope of the present invention as set forth in the appended claims.

1. A method for computing inter-domain optimal path in a network, comprising:
sending a request by a path computation client (PCC) to a path computation element (PCE) serving an ingress domain;
forwarding the request by the path computation element to each adjacent path computation element (PCEs), each adjacent path computation element serving one or more domains, wherein said domains are non-traversed;
forwarding the request by each adjacent path computation element to next adjacent path computation element until a response is received from the path computation element of the domain having a destination node;
computing a virtual shortest path tree path by each adjacent path computation element based on the response received; and
selecting the inter-domain optimal path from the virtual shortest path tree between the PCC and the destination node by the path computation element serving the ingress domain.

2. The method as claimed in claim 1, wherein a request parameters (RP) object in the PCE is set to “BRPC-Flood” to indicate a traversed domain.

3. The method as claimed in claim 2, further comprising: determining the traversed domains to avoid domain sequence loop.

4. The method as claimed in claim 3, further comprising: sending an error to the requesting path computation element on detecting the domain sequence loop.

5. The method as claimed in claim 1, wherein the virtual shortest path tree is computed by a backward recursive PCE-based computation (BRPC) procedure and constrained shortest path first (CSPF) procedure.

6. The method as claimed in claim 1, wherein the virtual shortest path tree comprises the ingress node, a boundary node, a branch node, a transit node and a destination node.

7. A system for computing an inter-domain optimal path in a network, comprising of:
a path computation client (PCC) configured to send a request to a path computation element (PCE) serving an ingress domain;
said path computation element serving an ingress domain configured to forward the request to each adjacent path computation element (PCEs) serving one or more domains; wherein said domains are non-traversed and said PCE also configure to select the inter-domain optimal path from the virtual shortest path tree between the PCC and the destination node;
each of said adjacent path computation element configured to forward the request to next adjacent path computation element until a response is received from the path computation element of the domain having a destination node; and
each of said path computation element serving one or more domains configured to compute a virtual shortest path tree path based on the response received.

8. The system as claimed in claim 7, wherein a request parameters (RP) object in the PCE is set to “BRPC-Flood” to indicate traversed domain.

9. The system as claimed in claim 8 further comprising the path computation element configured to determine the traversed domains to avoid domain loop.

10. The system as claimed in claim 9 further comprising sending an error to a requesting path computation element on detecting the domain loop.

11. The system as claimed in claim 7, wherein the virtual shortest path tree is computed by a backward recursive PCE-based computation procedure.

12. The system as claimed in claim 7, wherein the virtual shortest path tree comprises the ingress node, a boundary node, a branch node, a transit node and a destination node.

13. A network component for computing an inter-domain optimal path in a network, the network component comprising:
one or more network interfaces;
at least one processor connected to a network interface, said processor configured to
receive a request from a path computation client (PCC);
forward the request to each adjacent path computation element (PCEs) serving one or more domains; wherein said domains are non-traversed;
forward the request to next adjacent path computation element by each adjacent path computation element until a response is received from the path computation elements of the domain having a destination node;
computing a virtual shortest path tree path by each adjacent path computation element based on the response received; and
selecting the inter-domain optimal path from the virtual shortest path tree between the PCC and the destination node.

14. The network component as claimed in claim 13, wherein the request parameters (RP) object is set to “BRPC-Flood” to indicate the domains traversed.

15. The network component as claimed in claim 14 wherein said processor is configured to determine the traversed domains to avoid domain loop.

16. The network component as claimed in claim 15 wherein said processor is configured to receive an error on detecting the domain loop.

17. The network component as claimed in claim 13, wherein the virtual shortest path tree is computed by a backward recursive PCE-based computation procedure.

18. The network component as claimed in claim 13, wherein the virtual shortest path tree comprises the ingress node, a boundary node, a branch node, a transit node and a destination node.
